(19) United States
(12) Patent Application Publication
(10) Pub. No.: US 2026/0008442 A1
(43) Pub. Date: Jan. 8, 2026

(54) THERMAL MANAGEMENT OF ELECTROMECHANICAL BRAKE SYSTEM USING MOTOR TORQUE

(71) Applicant: HL MANDO CORPORATION, Gyeonggi-do (KR)

(72) Inventor: Jeremy DOBBS, Auburn, MI (US)

(21) Appl. No.: 19/219,425

(22) Filed: May 27, 2025

Related U.S. Application Data
(60) Provisional application No. 63/667,113, filed on Jul. 2, 2024.

(51) Int. Cl. B60T 8/172; B60T 13/74

(52) U.S. Cl. CPC B60T 8/172; B60T 13/741

(57) ABSTRACT

An electromechanical brake (EMB) system is provided. The EMB system includes: a brake rotor configured to be rotatable with a wheel of a vehicle; a brake pad assembly configured to be engageable with the brake rotor; an actuator assembly including an electric motor configured to mechanically move the brake pad assembly toward or away from the brake rotor; and an electronic control unit (ECU) including a processor associated with a memory that stores instructions that when executed by the processor causes the ECU to perform operations. The operations include: determining an occurrence of a torque reduction event; and reducing a motor torque of the electric motor while maintaining a clamp force exerted by the brake pad assembly on the brake rotor in response to determination of the occurrence of the torque reduction event.

### CROSS REFERENCE TO PARENT APPLICATIONS

This application claims the benefit of U.S. Patent Application Ser. No. 63/667,113 filed on Jul. 2, 2024, entitled “THERMAL MANAGEMENT THRU TORQUE OPTIMIZATION”, the entirety of which is incorporated herein by reference.

### BACKGROUND

Various embodiments of the present disclosure generally relate to an electromechanical brake (EMB) system (also referred to herein as an “EMB assembly”) and more particularly to a system and method for thermal management of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) system may comprise: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor; and an electronic control unit (ECU) comprising a processor associated with a memory that stores instructions that when executed by the processor causes the ECU to perform operations comprising: determining an occurrence of a torque reduction event; and reducing a motor torque of the electric motor while maintaining a clamp force exerted by the brake pad assembly on the brake rotor in response to determination of the occurrence of the torque reduction event.

The determining the occurrence of the torque reduction event comprises determining, by the ECU and while the vehicle is in a continuously braking state, whether the clamp force has exceeded a predetermined clamp force threshold.

The clamp force is maintained at an initial clamp force determined at a point during which the torque reduction event occurred.

The motor torque is reduced while the clamp force is maintained to reduce a motor temperature of the electric motor while the vehicle is in a continuously braking state.

The operations further comprise stopping the reducing of the motor torque.

The stopping of the reducing of the motor torque comprises determining, by the ECU, that the vehicle is no longer in a continuously braking state.

The stopping of the reducing of the motor torque comprises determining, by the ECU, that the vehicle is no longer in a continuously braking state.

The determining of the occurrence of the torque reduction event comprises receiving, from a main controller of the vehicle configured to control operations of the EMB system, braking commands for keeping the vehicle in a continuously braking state.

The determining of the occurrence of the torque reduction event comprises determining, by the ECU and while the vehicle is in a continuously braking state, whether the motor torque has exceeded a predetermined motor torque threshold.

The determining of the occurrence of the torque reduction event comprises determining, by the ECU and while the vehicle is in a continuously braking state, whether a temperature of the electric motor has exceeded a predetermined motor temperature threshold.

According to some embodiments of the present disclosure, a method for managing thermal properties of an electromechanical brake (EMB) system using motor torque is provided. The method is executed by an electronic control unit (ECU) of the EMB system and comprises: determining an occurrence of a torque reduction event; and reducing a motor torque of an electric motor of the EMB system while maintaining a clamp force exerted by a brake pad assembly of the EMB system on a brake rotor of the EMB system in response to determination of the occurrence of the torque reduction event, wherein the brake rotor is configured to be rotatable with a wheel of a vehicle on which the EMB system is installed and the brake pad assembly is configured to be engageable with the brake rotor, and wherein the EMB system further comprises an actuator assembly comprising the electric motor configured to mechanically move the brake pad assembly toward or away from the brake rotor.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2 shows a diagram illustrating a method for managing thermal properties of a brake assembly using motor torque according to one or more exemplary embodiments of the present disclosure.

FIG. 3. Shows a flow chart for illustrating a method for managing thermal properties of a brake assembly using motor torque according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

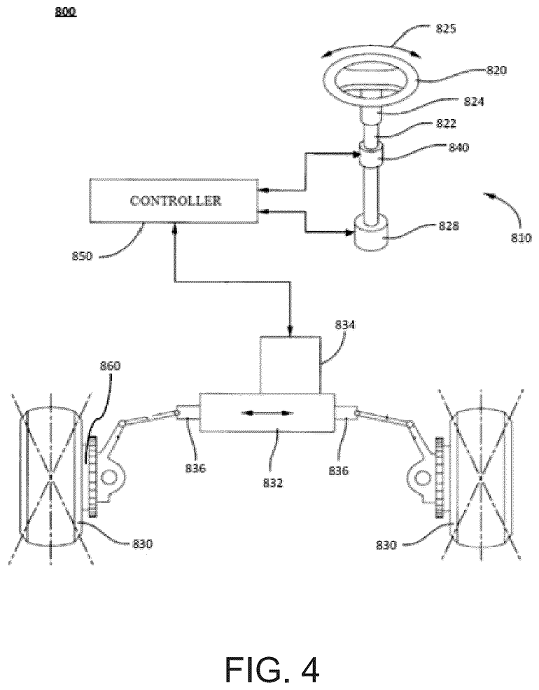

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Due to their mechanical nature, such brake systems may produce heat when certain parts of the system are engaged for too long (e.g., when the brakes are applied for a long period of time). Such heat (as a result of hysteresis) may result in faster deterioration of one or more parts of the brake systems (e.g., an electric motor of the brake systems or the like).

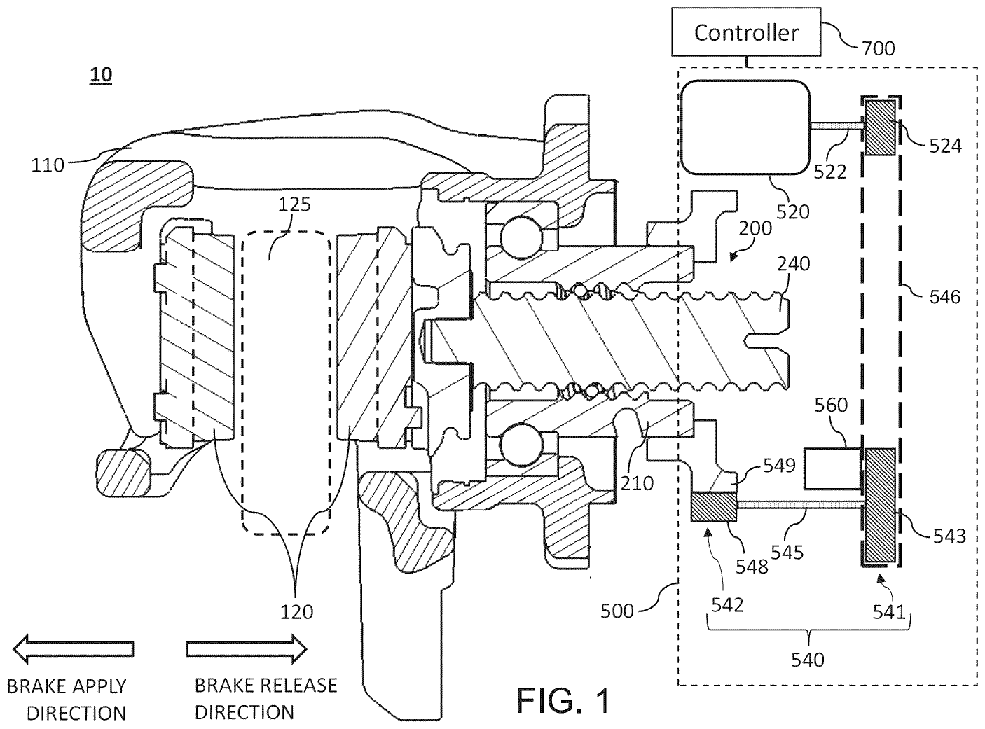

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatably part 210. Alternatively, the electric motor 520 is indirectly connected to the rotatably part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125).

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

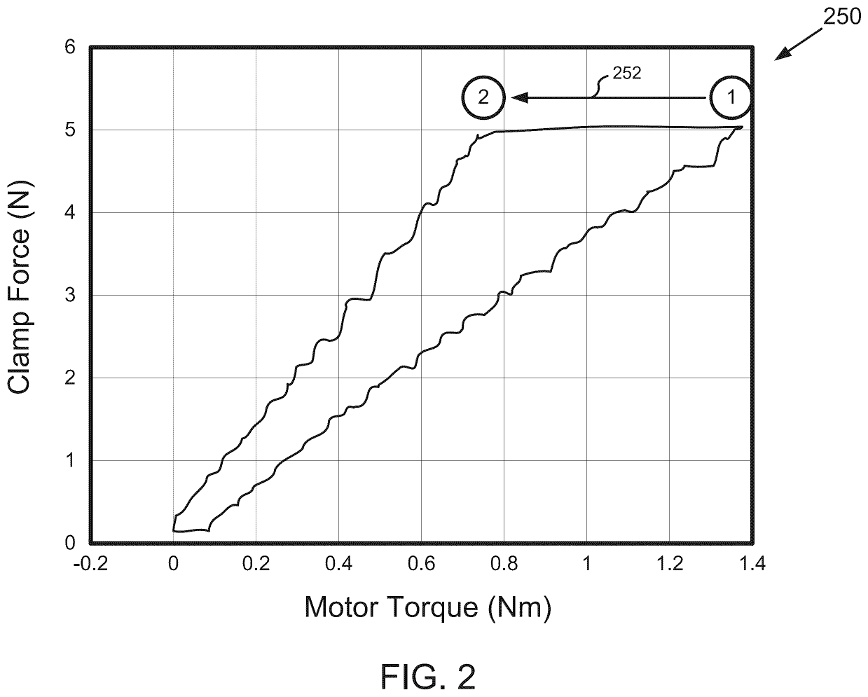

Turning now to FIG. 2, FIG. 2 shows a diagram 250 illustrating a method for managing thermal properties of a brake assembly using motor torque according to one or more exemplary embodiments of the present disclosure.

The diagram 250 of FIG. 2 includes a graph showing motor torque (Newton-meter (Nm)) plotted against clamp force (Newtons (N)). As shown in FIG. 2, motor torque (Nm) may start to increase from 0 Nm as braking force is applied by the braking assembly 10 (namely, when brake pad assembly 120 is translated to clamp onto and/or against the brake rotor 125 to stop a movement of the brake rotor 125). Such braking force may be applied when a driver of a vehicle is performing a braking action (e.g., stopping at a light, going down a hill, slowing down because of traffic, engaging in a parking maneuver, or the like). In embodiments, the driver may be a live human being. Alternatively, the driver may be an autonomous driving program (e.g., implemented using artificial intelligence (AI) or the like, or non-AI processes such as the cruise control systems already included in conventional vehicles) that is performing autonomous or semi-autonomous driving of the vehicle.

When such braking force is applied for a longer period of time (e.g., when the vehicle is temporarily stopped at a light or behind another vehicle, when the driver is constantly applying a braking action while driving down a hill or the like, or other situations that require constant application of the vehicle brakes without actually parking the vehicle), the motor torque (Nm) (e.g., of electric motor 520) may increase exponentially with the clamp force (N) (e.g., the force applied on the brake rotor 125). When the motor torque (Nm) and clamp force (N) increases to a certain point (e.g., point 1 shown in FIG. 2 represented by the numerical “1” shown in a circle) or peaks out, a hysteresis effect occurs that generates undesired heat in the electric motor 520, thereby negatively effecting the performance and durability of the electric motor 520.

To prevent the occurrence of such a hysteresis effect and to lower a temperature of (e.g., lower the amount of heat generated by) the electric motor 520 when a braking action is being applied for a longer period of time, the motor torque of the electric motor 520 may be lowered (e.g., by the controller 700 of the brake assembly 10).

In embodiments, the controller 700 may be configured to determine whether a torque reduction event has occurred (e.g., has been triggered). In one example of embodiments determined herein, the torque reduction event may be triggered when the controller 700 detects that a current clamp force (N) of the brake assembly 10 exceeds a predetermined clamp force threshold (e.g., a clamp force of 5 N as shown in the non-limiting example of FIG. 2). In another example of embodiments disclosed herein, the torque reduction event may be triggered when the controller 700 detects a large amount of force is being requested (e.g., through a sharp brake, through a constant application of the brakes by a driver, through one or a series of braking commands for keeping the vehicle in a continuously braking state, or the like) by a separate component of the vehicle such as, but not limited to, a main controller (e.g., controller 850) of the vehicle that controls the EMB system and the vehicle's steering system. In yet another example, the torque reduction event may be triggered when the controller 700 detects that the amount of torque (e.g., motor torque (Nm)) generated by the electric motor 520 has exceeded a predetermined torque threshold. In yet another example, the torque reduction event may be triggered when the controller 700 detects that a temperature of the electric motor 520 (i.e., motor temperature) has exceeded a predetermined motor temperature threshold.

The torque reduction event may also be triggered through other combination of events (e.g., when both the motor torque (Nm) and the clamp force (N) reach predetermined thresholds, or the like) and is not limited to being triggered by only the above-listed events. Without departing from the scope of embodiments disclosed herein, any of the predetermined thresholds discussed herein (e.g., the predetermined clamp force threshold, the predetermined torque threshold, the predetermined motor temperature threshold, etc.) may be set by a manufacturer of the brake assembly 10 and/or of the vehicle in which the brake assembly 10 is installed.

The clamp force (N), motor torque (Nm), and other properties of the brake assembly 10 detected by the controller 700 may be measured (e.g., obtained) using any of the sensors discussed above in reference to FIG. 1 and/or be calculated using any of the data obtained by any of the sensors discussed above in reference to FIG. 1. For example, the brake assembly 10 may not be configured with a force sensor (e.g., brake assembly 10 translatable part 240b may be a force-sensor-less brake assembly) and the clamp force (N) applied on the brake rotor 125 may instead be calculated using one or more of the other measured properties such as, but not limited to: a motor angle of the electric motor 520; a linear position of the translatable part 240 and/or a linear position of the brake pad of the brake pad assembly 120 that is connected to translatable part 240, a motor torque of the electric motor 520; or the like.

As shown in FIG. 2, the torque reduction event may be triggered at point 1 (represented by the numerical “1” shown in a circle) of FIG. 2.

In embodiments, upon triggering of the torque reduction event, the controller 700 may cause the electric motor 520 to reduce the motor torque (Nm) being generated while retaining the same amount of clamp force (N) at the point which the torque reduction event is generated.

For example, as shown in FIG. 2, once point 1 has been reached (e.g. once the torque reduction event has been triggered), the motor torque (Nm) starts decreasing (e.g., towards point 2 on the graph of the diagram 250 of FIG. 2) while the clamp force (N) remains the same as the clamp force (N) detected (e.g., measured, calculated, determined, etc.) at point 1 when the reduction event is triggered. As a result, the vehicle may still maintain the braking action required by the driver while a heat generation of the electric motor 520 (which is related to the motor torque) decreases, thereby effectively lowering a temperature of the electric motor 520 and reducing the amount of hysteresis effect generated. Said another way, system braking output of the brake assembly 10 is maintained while the electric motor 520's thermal capabilities increases (e.g., are improved), which directly improves performance and durability (and lifetime) of the braking assembly 10 since the braking assembly 10 can now maintain a required braking output for a longer period of time (without the risk of overheating and/or generating temperatures that could hasten the deterioration and lower the durability of the electric motor 520).

In embodiments, upon triggering of the torque reduction event, the controller 720 may reduce the motor torque (Nm) until: (i) receiving another signal and/or command from the main controller of the vehicle that the braking action is no longer needed (e.g., the driver has lifted his/her foot off the brakes, an autonomous program controlling (e.g., driving) the vehicle has determined that braking is no longer needed, or the like); or (ii) the controller 720 determines (e.g., detects based on readings and/or measurements from one or more sensors) that the clamp force (N) being applied on the brake rotor 125 is starting to decreases as a result of the motor torque (Nm) being reduced to a point where the brake pad assembly 120 is unable to maintain the current clamp force (N) on the brake rotor 125. In situation (ii), the controller 720 has still not received a stop braking signal and/or command from the main controller of the vehicle and the intention of the driver is still to keep the vehicle in a constant braking state.

In the example of situation (i), once braking is no longer needed, the controller 720 disengages from (e.g., stops) the torque reduction event and returns to normal operation as the vehicle transitions from the braking state to a driving state. In the example of situation (ii), once the controller 720 determines that the clamp force (N) is starting to decrease (e.g., as shown in point 2 represented by the numerical “2” shown in a circle in FIG. 2) (i.e., that the amount of motor torque (Nm) generate by the electric motor 520) is unable to maintain the current clamp force (N) required for the driver's desired braking action(s)), the controller 720 may (i) stop the reduction of the motor torque (Nm) and hold the motor torque (Nm) constant at point 2, (ii) increase the motor torque (Nm) slightly to recover the loss of clamp force (N) detected, or any other appropriate action to ensure the that clamp force (N) does not decrease any further such that the brake pad assembly 120 is able to maintain the necessary grip (e.g., clamp force (N)) on the brake rotor 125 to provide the desired braking action of the driver.

In embodiments, the period between point 1 and point 2 of FIG. 2 may be referred to herein as motor torque reduction period 252. The motor torque (Nm) may be reduced within this motor torque reduction period 252 at a predetermined (e.g., preset) torque reduction rate while the clamp force (N) is maintained at the value detected (e.g., measured, calculated, determined, etc.) when the torque reduction event is triggered at point 1. The predetermined torque reduction rate may be set by a manufacturer of the brake assembly 10 and/or of the vehicle based on properties, specifications, operation requirements, and/or operation specifications/ratings of the brake assembly 10 and/or of the vehicle.

As discussed, the heat generated by the electric motor 520 may decrease during this motor torque reduction period 252, thereby effectively lowering an operating temperature of the electric motor 520 (and other parts that the electric motor 520 actuates and/or is connected to). Such lowering of the operating temperature of the electric motor 520 advantageously reduces the amount of hysteresis effect experienced by the electric motor 520, which directly improves the not only the durability but also the long-term performance of the electric motor 520.

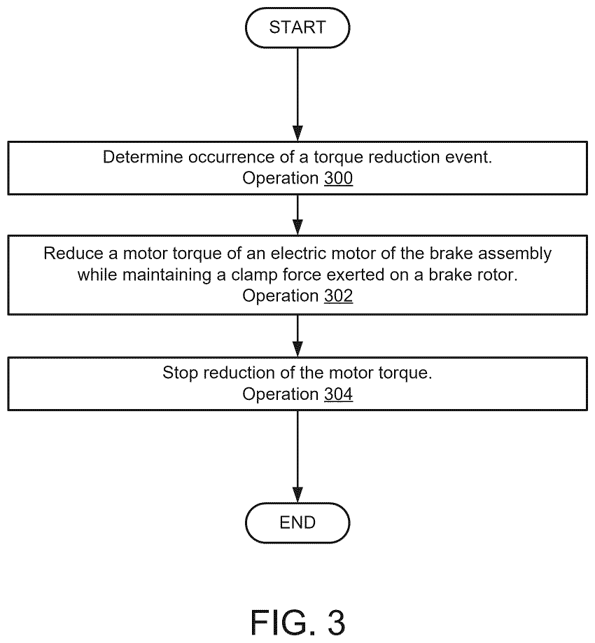

Turning to FIG. 3, a flowchart illustrating a method for managing thermal properties of a brake assembly using motor torque according to one or more exemplary embodiments of the present disclosure. The operations of the flowchart of FIG. 3 may be performed, for example, by the controller 700 of the brake assembly 10. Although shown as a series of temporal steps, the operations of the flowchart 3 need not be performed in the exact order shown in FIG. 3 and any of the operations can be performed in any order without departing from the scope and spirit of embodiments disclosed herein.

In Operation 300, and as discussed above in reference to FIG. 2, the controller 700 of brake assembly 10 may determine that a torque reduction event has occurred.

In embodiments, the torque reduction event may be triggered (e.g., may be determined by the controller 700 to have occurred) based on one or more events (e.g., a predetermined clamp force threshold being reached, a predetermined motor temperature being reached, a predetermined braking action being received as a signal and/or command by controller 700 of the brake assembly 10 from a main controller of the vehicle, or the like).

The torque reduction event may indicate to the controller that the electric motor 520 is going to start generating (and/or reach) a temperature that could negatively impact a performance and durability of the electric motor 520 (e.g., the electric motor 520 is set to experience undesired hysteresis effects).

In Operation 302, and as discussed above in reference to FIG. 2, a motor torque of the electric motor 520 is reduced by the controller 700. While the motor torque of electric motor 520 is reduced, the clamp force (N) of the brake assembly 10 (e.g., the clamp force exerted on brake rotor 125 by brake pad assembly 120) is maintained at a level (e.g., value) that was detected at the occurrence of the torque reduction event.

For example, as shown in FIG. 2, the clamp force (N) detected during the occurrence of the torque reduction event at point 1 of FIG. 2 was approximately 5 N. This clamp force of 5 N is maintained over the duration of the motor torque reduction period 525 during which the motor torque (Nm) of the electric motor 520 is reduced by controller 700.

In Operation 304, and as discussed above in reference to FIG. 2, the reduction of the motor torque may be stopped (e.g., ended) by controller 700.

For example, the reduction of the motor torque may be stopped when the controller 700 stops receiving a braking command from the main controller of the vehicle. As another example, the reduction of the motor torque may be stopped when the controller 700 determines that (while the controller 700 is still receiving the braking command) the clamp force (N) has decreased from the initial value detected during the occurrence of the torque reduction event.

In embodiments, while the controller 700 of brake assembly 10 continues to receive the braking command from the main controller of the vehicle, the motor torque of electric motor 520 may be continuously adjusted (e.g., reduced and/or increased) in order to reduce a motor temperature of the electric motor 520 while the vehicle is in a continuously braking state.

The method of FIG. 3 may end following Operation 304.

Any of the operations (e.g., Operations 300 through 304) discussed in reference to FIG. 3 may be performed, in part or whole, by digital processors (e.g., central processors, processor cores, etc.) that execute corresponding instructions (e.g., computer code/software) of controller 700. Execution of the instructions may cause the digital processors to initiate performance of the processes. Any portions of the operations (e.g., Operations 300 through 304) may be performed by the digital processors and/or other devices. For example, executing the instructions may cause the digital processors to perform actions that directly contribute to performance of the operations, and/or indirectly contribute to performance of the operations by causing (e.g., initiating) other hardware components to perform actions that directly contribute to the performance of the operations.

Additionally, any of the operations discussed in reference to FIG. 3 may be performed, in part or whole, by special purpose hardware components of the controller 700 such as digital signal processors, application specific integrated circuits, programmable gate arrays, graphics processing units, data processing units, and/or other types of hardware components. These special purpose hardware components may include circuitry and/or semiconductor devices adapted to perform the operations. For example, any of the special purpose hardware components may be implemented using complementary metal-oxide semiconductor-based devices (e.g., computer chips).

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) system comprising:
a brake rotor configured to be rotatable with a wheel of a vehicle;
a brake pad assembly configured to be engageable with the brake rotor;
an actuator assembly comprising an electric motor configured to mechanically move the brake pad assembly toward or away from the brake rotor; and
an electronic control unit (ECU) comprising a processor associated with a memory that stores instructions that when executed by the processor causes the ECU to perform operations comprising:
determining an occurrence of a torque reduction event; and
reducing a motor torque of the electric motor while maintaining a clamp force exerted by the brake pad assembly on the brake rotor in response to determination of the occurrence of the torque reduction event.

2. The EMB system of claim 1, wherein the determining the occurrence of the torque reduction event comprises:
determining, by the ECU and while the vehicle is in a continuously braking state, whether the clamp force has exceeded a predetermined clamp force threshold.

3. The EMB system of claim 2, wherein the clamp force is maintained at an initial clamp force determined at a point during which the torque reduction event occurred.

4. The EMB system of claim 3, wherein the motor torque is reduced while the clamp force is maintained to reduce a motor temperature of the electric motor while the vehicle is in a continuously braking state.

5. The EMB system of claim 3, wherein the operations further comprise:
stopping the reducing of the motor torque.

6. The EMB system of claim 5, wherein the stopping of the reducing of the motor torque comprises:
determining, by the ECU, that the vehicle is no longer in a continuously braking state.

7. The EMB system of claim 5, wherein the stopping of the reducing of the motor torque comprises:
determining, by the ECU, that the initial clamp force has decreased.

8. The EMB system of claim 1, wherein the determining of the occurrence of the torque reduction event comprises:
receiving, from a main controller of the vehicle configured to control operations of the EMB system, braking commands for keeping the vehicle in a continuously braking state.

9. The EMB system of claim 1, wherein the determining of the occurrence of the torque reduction event comprises:
determining, by the ECU and while the vehicle is in a continuously braking state, whether the motor torque has exceeded a predetermined motor torque threshold.

10. The EMB system of claim 1, wherein the determining of the occurrence of the torque reduction event comprises:
determining, by the ECU and while the vehicle is in a continuously braking state, whether a temperature of the electric motor has exceeded a predetermined motor temperature threshold.

11. A method configured to be executed by an electronic control unit (ECU) associated with an electromechanical brake (EMB) system, the method comprising:
determining an occurrence of a torque reduction event; and
reducing a motor torque of an electric motor of the EMB system while maintaining a clamp force exerted by a brake pad assembly of the EMB system on a brake rotor of the EMB system in response to determination of the occurrence of the torque reduction event,
wherein the brake rotor is configured to be rotatable with a wheel of a vehicle on which the EMB system is installed and the brake pad assembly is configured to be engageable with the brake rotor, and
wherein the EMB system further comprises an actuator assembly comprising the electric motor configured to mechanically move the brake pad assembly toward or away from the brake rotor.

12. The method of claim 11, wherein the determining of the occurrence of the torque reduction event comprises:
determining, by the ECU and while the vehicle is in a continuously braking state, whether the clamp force has exceeded a predetermined clamp force threshold.

13. The method of claim 12, wherein the clamp force is maintained at an initial clamp force determined at a point during which the torque reduction event occurred.

14. The method of claim 13, wherein the motor torque is reduced while the clamp force is maintained to reduce a temperature of the electric motor while the vehicle is in the continuously braking state.

15. The method of claim 13, wherein the method further comprises:
stopping the reducing of the motor torque.

16. The method of claim 15, wherein the stopping of the reducing of the motor torque comprises:
determining, by the ECU, that the vehicle is no longer in a continuously braking state.

17. The method of claim 15, wherein the stopping of the reducing of the motor torque comprises:
determining, by the ECU, that the initial clamp force has decreased.

18. The method of claim 11, wherein the determining of the occurrence of the torque reduction event comprises:
receiving, from a main controller of the vehicle configured to control operations of the EMB system, braking commands for keeping the vehicle in a continuously braking state.

19. The method of claim 11, wherein the determining of the occurrence of the torque reduction event comprises:
determining, by the ECU and while the vehicle is in a continuously braking state, whether the motor torque has exceeded a predetermined motor torque threshold.

20. The method of claim 11, wherein the determining of the occurrence of the torque reduction event comprises:
determining, by the ECU and while the vehicle is in a continuously braking state, whether a temperature of the electric motor has exceeded a predetermined motor temperature threshold.
